(19) United States
(12) Patent Application Publication
(10) Pub. No.: US 2009/0102465 A1
(43) Pub. Date: Apr. 23, 2009

(54) MAGNETO-RESISTIVE SENSORS WITH IMPROVED OUTPUT SIGNAL CHARACTERISTICS

(75) Inventors: Theodorus Petrus Henricus Gerardus Jansen, Deurne (NL); Josephus Arnoldus Henricus Maria Kahlman, Tilburg (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/299,784

(22) PCT Filed: May 10, 2007
(86) PCT No.: PCT/IB2007/051637

§ 371 Date: Nov. 6, 2008

(30) Foreign Application Priority Data
May 10, 2006 (EP) 06113759.2

(51) Int. Cl. G01N 27/74

(52) U.S. Cl. 324/207.21

(57) ABSTRACT

The present invention provides a magnetoresistive sensor (20) comprising a stabilizing circuit for stabilizing an electrical output signal (Uₒ) of the magnetoresistive sensor (20) in order to correct for the contribution of an internal magnetic field generated by a magnetoresistive element (21) which is part of the sensor (20). The present invention furthermore provides a biochip comprising at least one such magnetoresistive sensor (20) and a method for stabilizing the electrical output signal (Uₒ) of a magnetoresistive sensor (20).

The present invention relates to magnetoresistive sensors, and more particularly to magnetoresistive sensors having a stabilized output signal. The present invention furthermore relates to biosensors or biochips comprising such magnetoresistive sensors, to the use of such magnetoresistive sensors, and to a method for stabilizing the output signal of a magnetoresistive sensor.

Magnetoresistive sensors based on AMR (anisotropic magneto resistance), GMR (giant magneto resistance) and TMR (tunnel magneto resistance) elements are nowadays gaining importance. Besides the known high-speed applications such as magnetic hard disk heads and MRAM, new relatively low bandwidth applications appear in the field of molecular diagnostics (MDx), current sensing in IC's, automotive, etc.

The introduction of micro-arrays or biochips comprising such magnetoresistive sensors is revolutionising the analysis of DNA (desoxyribonucleic acid), RNA (ribonucleic acid) and proteins. Applications are e.g. human genotyping (e.g. in hospitals or by individual doctors or nurses), bacteriological screening, biological and pharmacological research. Such magnetoresistive biochips have promising properties for, for example, biomolecular diagnostics, in terms of sensitivity, specificity, integration, ease of use and costs.

Biochips, also called biosensor chips, biological microchips, gene-chips or DNA chips, consist in their simplest form of a substrate on which a large number of different probe molecules are attached, on well defined regions on the chip, to which molecules or molecule fragments that are to be analysed can bind if they are perfectly matched. For example, a fragment of a DNA molecule binds to one unique complementary DNA (c-DNA) molecular fragment. The occurrence of a binding reaction can be detected, for example by using markers, e.g. fluorescent markers or magnetic labels, that are coupled to the molecules to be analysed. This provides the ability to analyse small amounts of a large number of different molecules or molecular fragments in parallel, in a short time. One biochip can hold assays for 1000 or more different molecular fragments. It is expected that the usefulness of information that can become available from the use of biochips will increase rapidly during the coming decade, as a result of projects such as the Human Genome Project, and follow-up studies on the functions of genes and proteins.

A biosensor consisting of an array of, for example 100, sensors based on the detection of e.g. superparamagnetic beads may be used to simultaneously measure the concentration of a large number of different biological molecules (e.g. protein, DNA) in a solution (e.g. blood). This may be achieved by attaching a superparamagnetic bead to target molecules which are to be determined, magnetizing this bead with an applied magnetic field and using e.g. a Giant Magneto Resistance (GMR) sensor to detect the magnetic field of the magnetized beads.

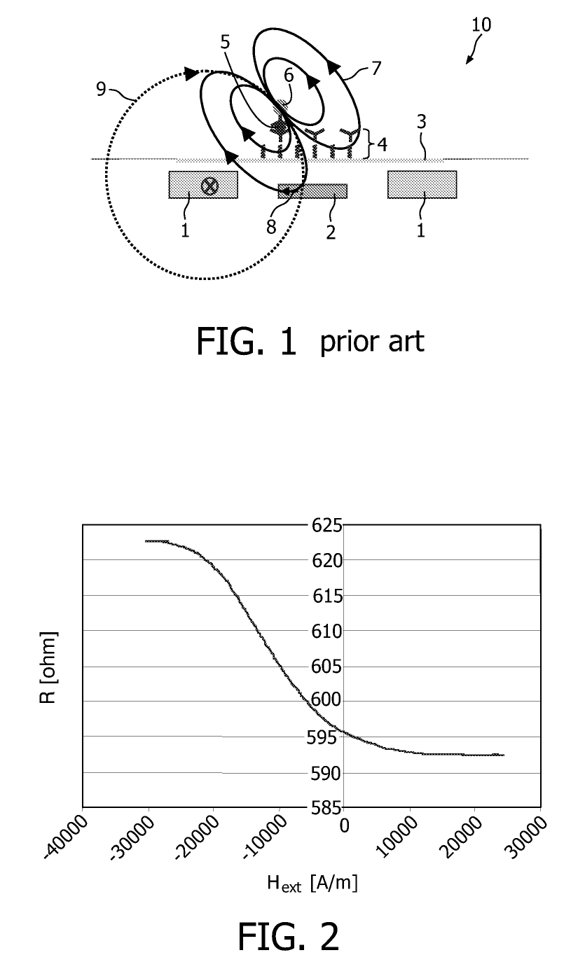

FIG. 1 illustrates a magnetoresistive sensor 10 with integrated magnetic field excitation. With integrated magnetic field excitation is meant that a magnetic field generating means is integrated in the magnetoresistive sensor 10. The magnetoresistive sensor 10 comprises two electric conductors 1 which form the magnetic field generator and a GMR element 2 which forms a magnetoresistive sensor element. At the surface 3 of the magnetoresistive sensor 10, binding sites 4 are provided to which, for example, target molecules 5 with attached thereto a magnetic nanoparticle 6, can bind. A current flowing through the conductors 1 generates a magnetic field which magnetizes the magnetic nanoparticle 6. The magnetic nanoparticle 6 develops a magnetic moment m indicated by field lines 7 in FIG. 1. The magnetic moment m then generates dipolar magnetic fields, which have in-plane magnetic field components 8 at the location of the GMR element 2. Thus, the magnetic nanoparticle 6 deflects the magnetic field 9 induced by the current through the conductor 1, resulting in the magnetic field component 8 in the sensitive x-direction of the GMR element 2, also called x-component of the magnetic field Hₑₓₜ. The x-component of the magnetic field Hₑₓₜ is then sensed by the GMR element 2 and depends on the number Nₙₚ of magnetic nanoparticles 6 present at the surface 3 of the magnetoresistive sensor 10 and on the magnitude of the conductor current.

The in-plane magnetic field component Hₑₓₜ in the GMR element 2 results in a resistance change ΔR_{GMR}(Hₑₓₜ) of the GMR element 2. FIG. 2 shows the GMR resistance as a function of the in-plane magnetic field component Hₑₓₜ in the sensitive layer of the GMR stack. The sensitivity of the magnetoresistive sensor 10, which is expressed as:

$${s}_{GMR} = \frac{d {R}_{GMR}}{d {H}_{ext}} \qquad ( 1 )$$

is not constant but depends on non-controllable parameters such as, for example, production tolerances, ageing effects and temperature. Therefore also the effective gain of the measurement performed by the magnetoresistive sensor 10, is sensitive to these non-controllable parameters.

A solution to this problem is described in PCT/IB2005/053935. This document describes the use of the 2^{nd} harmonic in the signal sensed by the magnetoresistive sensor, and optionally other harmonics such as, for example, the 4^{th} harmonic, in the magnetoresistive (MR) voltage as a gain indicator to be used for stabilizing the sensitivity of the magnetoresistive sensor. The harmonics are generated by the self-magnetizing property of the magnetoresistive sensor element.

A disadvantage of this approach is that it increases the complexity of the required hardware and the instability because of the large 65 dB dynamic range between the desired gain indicating 2^{nd} harmonic 2f₂ and the base band signal at frequency f₂, which requires high order bandpass filtering, and because of the need for additional detection circuitry at frequency 2f₂.

It is an object of the present invention to provide a magnetoresistive sensor device with good electrical output signal characteristics, a biochip comprising at least one such magnetoresistive sensor and a method for stabilizing an electrical output signal of a magnetoresistive sensor. The above objective is accomplished by a method and device according to the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

The present invention provides a magnetoresistive sensor comprising:
a magnetic field generator for generating a magnetic field, further called the generated magnetic field,
at least one magnetoresistive element for sensing a magnetic field,
a current source for flowing a sense current (Iₛₑₙₛₑ) through the at least one magnetoresistive element thus generating a sense signal which depends on the sensed magnetic field, and
electronic means for generating an electrical output signal having an amplitude and being derived from the sense signal, the electronic means comprising stabilizing circuitry,

wherein the stabilizing circuitry comprises means for stabilizing an electrical output signal component which is indicative for the generated magnetic field.

The present invention provides a magnetoresistive sensor comprising:
a magnetic field generator for generating a magnetic field,
at least one magnetoresistive element for sensing the magnetic field,
a current source for flowing a sense current (Iₛₑₙₛₑ) through the at least one magnetoresistive element thus generating a sense signal which depends on the sensed magnetic field, and
electronic means for generating an electrical output signal having an amplitude and being derived from the sense signal, the electronic means comprising stabilizing circuitry,

wherein the stabilizing circuitry comprises means for determining a DC component in the sense signal and means for stabilizing the amplitude of the electrical output signal in response to said DC component.

By interpreting the DC component in the sense signal as a gain indicator rather than using the 2^{nd} (or higher) harmonic in the sense signal as in prior art solutions, the drawbacks which appear in the magnetoresistive sensors according to those prior art solutions can be limited or even omitted.

A further advantage of the magnetoresistive sensor according to the present invention is that it suppresses variations in the sense current so that a controllable high ohmic voltage source may be used instead of a real current source for delivering the sense current. This eases the implementation of a low-noise sense current generator. A low-noise voltage source is easier to realize by, for example, filtering the output in the frequency domain.

The electrical output signal of the magnetoresistive sensor thus does not suffer from variations in the sensitivity S_{GMR} of the magnetoresistive element or variations in I₂ or amplitude of the sense current Iₛₑₙₛₑ or in other words fluctuations of the current source.

The magnetoresistive element may be a GMR, a TMR or an AMR element. The magnetic field generator may comprise at least one electrical conductor. The at least one electrical conductor may be formed by at least one conducting wire.

According to embodiments of the invention, the means for determining the DC component may comprise a low-pass filter, preferably a DC or 0 Hz filter. Preferably, the low-pass filter may be a low-order low-pass filter, most preferably a 1^{st} to 3^{rd}-order filter. The means for stabilizing the amplitude of the electronic output signal may comprise a normalizer controlled by the magnitude of the DC component in the sense signal. With the device according to these embodiments, the amplitude of the electrical output signal U₀ is controlled pure electronically. The device according to these embodiments only requires a simple low-pass filter, because the DC component has to be separated from frequency ω₁ which is much higher than the frequency of the DC component, whereas in the device according to the prior art where the second (or higher) harmonic is used for stabilizing the output signal, two frequencies ω₁ and ω₂ which are less different from each other are to be separated from each other. This is much more difficult and thus more complicated components may be required.

According to embodiments of the invention, the stabilising circuitry may comprises a feedforward loop.

According to other embodiments, the stabilising circuitry may comprise a feedback loop.

According to embodiments of the invention, the feedback loop may comprise a subtractor and an integrating loop filter. According to other embodiments, the feedback loop may furthermore comprise a multiplier which may be controlled by the output of the integrating loop filter. In the device according to this embodiment, the magnetoresistive element is used as a gain multiplier.

The device according to this embodiment will suffer less from possible complication for the design with respect to, for example, stability, because the feedback loop contains less elements in the loop as, contrary to the implementation according to the previous embodiment, the controllable current source and the GMR element are not present in the feedback loop.

According to embodiments of the present invention, the electrical means may furthermore comprise an amplifier for amplifying the sense signal.

According to embodiments of the present invention, the magnetic field generator may be adapted for magnetizing a magnetizable object and the at least one magnetoresistive element may be adapted for sensing a magnetic field generated by the magnetizable object when magnetized. The device according to these embodiments may be used for detecting target molecules present in a sample and labelled with magnetic particles.

The magnetoresistive sensor according to embodiments of the present invention may be used in molecular diagnostics, biological sample analysis or chemical sample analysis.

The present invention also provides a biochip comprising at least one magnetoresistive sensor according to the present invention.

According to embodiments of the invention, the biochip may comprise a plurality of magnetoresistive sensors, wherein at least one magnetoresistive sensor may be used as reference sensor and wherein stabilization of the amplitude of the electrical output signal of the magnetoresistive sensors may be performed by using information derived from the at least one reference sensor.

The biochip according to embodiments of the present invention may be used in molecular diagnostics, biological sample analysis or chemical sample analysis.

The present invention furthermore provides a method for stabilizing an electrical output signal component indicative for a generated magnetic field in a magnetic field generator of a magnetoresistive sensor. The method comprises:
generating a magnetic field, further called the generated magnetic field,
generating a sense signal indicative for the magnetic field induced by a sense current in a magnetoresistive element, and
generating an electrical output signal derived from said sense signal, wherein the method furthermore comprises:
stabilizing the electrical output signal component which is indicative for the generated magnetic field.

The present invention furthermore provides a method for stabilizing the amplitude of an electrical output signal of a magnetoresistive sensor. The method comprises:
generating a magnetic field,
generating a sense signal indicative for the magnetic field induced by a sense current in a magnetoresistive element, and
generating an electrical output signal derived from said sense signal, wherein the method furthermore comprises:
determining a DC component from said sense signal, and
stabilizing the amplitude of the electrical output signal indicative for the magnetic field in response to said determined DC component.

By interpreting the DC component in the sense signal as a gain indicator rather than using the 2^{nd} (or higher) harmonic in the sense signal as in prior art solutions, the drawbacks which appear in the magnetoresistive sensors according to those prior art solutions can be limited or even omitted.

A further advantage of the method according to the present invention is that it allows to suppress variations in the sense current so that a controllable high ohmic voltage source may be used instead of a real current source for delivering the sense current. This eases the implementation of a low-noise sense current generator. A low-noise voltage source is easier to realize by, for example, filtering the output in the frequency domain.

According to embodiments of the invention, determining a DC component may be performed by extracting said DC component from the sense signal by low-pass filtering. The method according to these embodiments only requires a simple low-pass filter, because the DC component has to be separated from frequency co) which is much higher than the frequency of the DC component, whereas in the method according to the prior art where the second (or higher) harmonic is used for stabilizing the output signal, two frequencies ω₁ and ω₂ which are less different from each other are to be separated from each other and thus more complicated components may be required.

According to embodiments of the invention, stabilizing the amplitude of the electrical output signal may be performed by a normalizer.

According to an embodiment of the invention, generating a magnetic field may comprise generating a magnetic field for magnetizing a magnetizable object, and sensing the magnetic field may comprise sensing the magnetic field generated by said magnetizable object when magnetized.

The method according to embodiments of the present invention may be used in molecular diagnostics, biological sample analysis or chemical sample analysis.

The teachings of the present invention permit the design of improved methods and apparatus for stabilising the amplitude of an electrical output signal of a magnetoresistive sensor.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 illustrates a magnetoresistive sensor with integrated magnetic field excitation as known from the prior art.

FIG. 2 shows the resistance of a GMR element as a function of an applied external magnetic field.

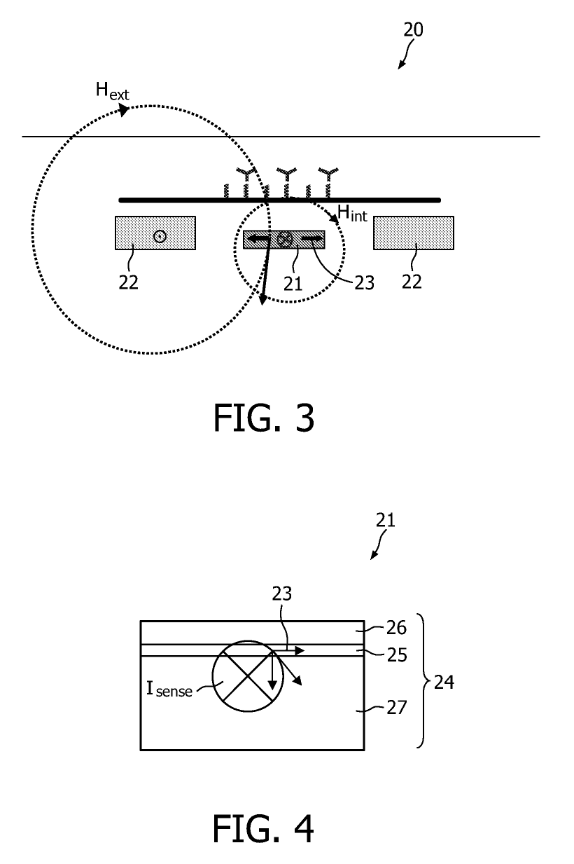

FIG. 3 schematically illustrates magnetic crosstalk in a magnetoresistive sensor.

FIG. 4 shows a cross-section of a GMR stack in which the current through the stack is schematically indicated.

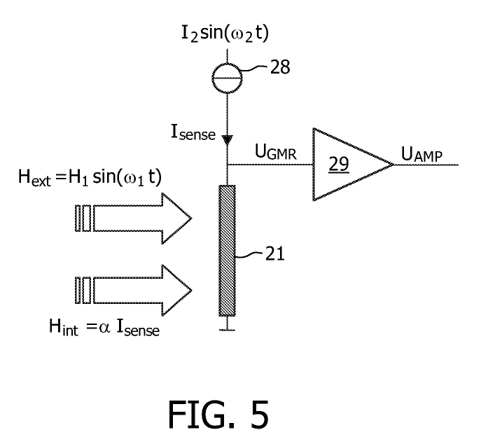

FIG. 5 schematically illustrates the contributions of, on the one hand, an external magnetic field generated by flowing a current through a magnetic field generating means and, on the other hand, an internal magnetic field generated by the magnetoresistive sensor element itself.

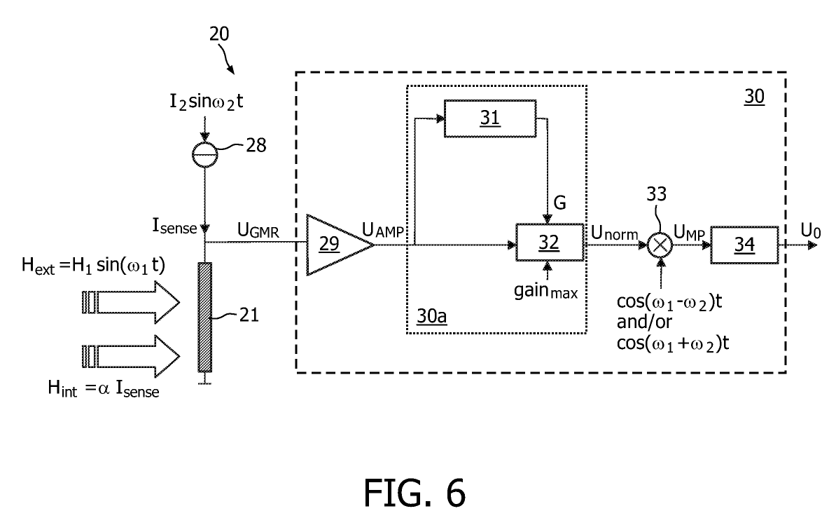

FIG. 6 schematically illustrates a magnetoresistive sensor device according to an embodiment of the present invention.

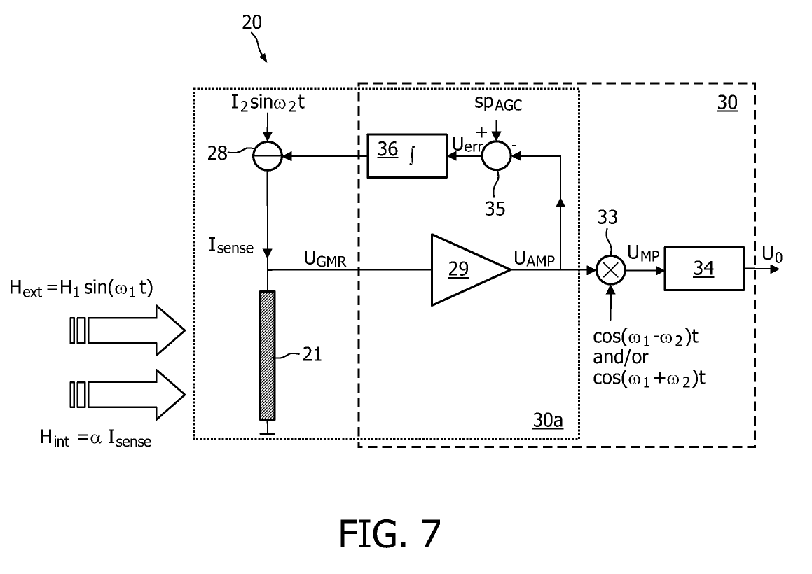

FIG. 7 schematically illustrates a magnetoresistive sensor device according to another embodiment of the present invention.

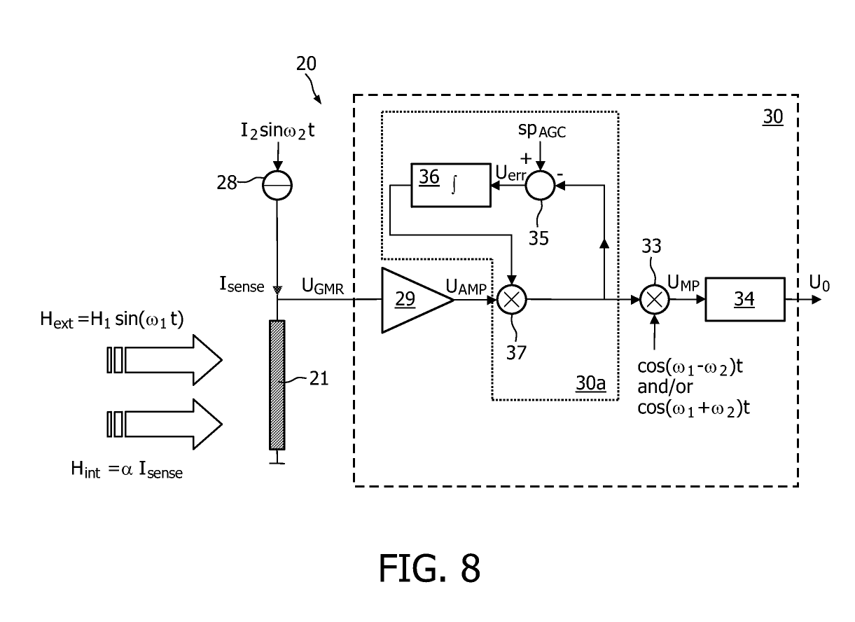

FIG. 8 schematically illustrates a magnetoresistive sensor device according to yet another embodiment of the present invention.

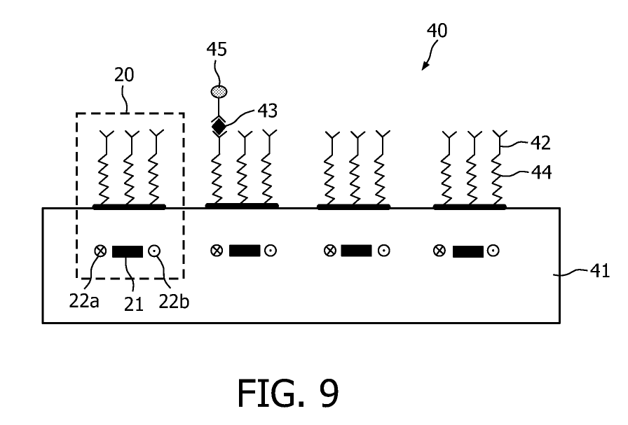

FIG. 9 illustrates a biochip comprising magnetoresistive sensors according to embodiments of the present invention.

In the different figures, the same reference signs refer to the same or analogous elements.

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

The present invention relates to magnetoresistive sensors with stabilised electrical output signal characteristics, to a biochip comprising at least one such magnetoresistive sensor and to a method for stabilizing an electrical output signal of a magnetoresistive sensor. With stabilised electrical output signal characteristics is meant that the electrical output signal is made independent from variations in the sensitivity s_{GMR} of a magnetoresistive element present in the sensor and on variations in the amplitude of a sense current sent through the magnetoresistive element. Moreover, the magnetic sensor can be any suitable sensor based on the detection of the magnetic properties of particles to be measured on or near to the sensor surface. Therefore, the magnetic sensor is designable as a coil, magneto-resistive sensor, magneto-restrictive sensor, Hall sensor, planar Hall sensor, flux gate sensor, SQUID (Semiconductor Superconducting Quantum Interference Device), magnetic resonance sensor, or as another sensor actuated by a magnetic field.

A magnetoresistive sensor according to the present invention comprises a magnetic field generator for generating a magnetic field, further also called the generated magnetic field, at least one magnetoresistive element for sensing a magnetic field, a current source for flowing a sense current Iₛₑₙₛₑ through the at least one magnetoresistive element thereby generating a sense signal which depends on the sensed magnetic field, and read out electronics for generating an electrical output signal having an amplitude and being derived from the sense signal, the read out electronics comprising stabilizing circuitry. According to the present invention, the stabilizing circuitry comprises means for determining a DC component in the sense signal and means for stabilizing the amplitude of the electrical output signal by using the DC component or, more generally worded, the stabilizing circuitry comprises means for stabilizing an electrical output signal component which is indicative for the generated magnetic field.

The magnetic field generator may be for magnetizing a magnetizable object present in the neighbourhood of the magnetoresistive sensor and attached to target molecules to be detected. The magnetizable object is preferably a magnetic nanoparticle, but may also be any other suitable magnetizable object, which can be attached to target molecules. The present invention will further be described by means of one or more magnetoresistive sensors having a magnetic field generator for magnetising magnetisable objects and at least one magnetoresistive element for sensing a magnetic field generated by the magnetisable objects when magnetised, wherein the magnetisable objects are magnetic nanoparticles. According to embodiments of the present invention the magnetic field generator may comprise at least one conductor. It has to be understood that this is not limiting the invention in any way.

The at least one magnetoresistive element is for sensing a magnetic field generated by the magnetic field generator, or generated by the magnetizable object, e.g. magnetic nanoparticle, when magnetised by the magnetic field generated by the magnetic field generator. According to embodiments of the present invention, the magnetoresistive element may be an element in which the electrical resistance changes when the magnetization direction of one or more layers changes as a result of the application of a magnetic filed, such as a giant magnetoresistive (GMR), tunnel magnetoresistive (TMR) or anisotropic magnetoresistive (AMR) element.

In GMR technology, structures have been developed in which two thin magnetic films are brought close together. A first magnetic film is pinned, which means that its magnetic orientation is fixed, usually by holding it in close proximity to an exchange bias layer, a layer of antiferromagnetic material that fixes the first magnetic film's magnetic orientation. A second magnetic layer or free layer, has a free, variable magnetic orientation. Changes in the magnetic field which, according to the present invention originate from changes in the magnetization of magnetic material such as, for example, magnetic nanoparticles (e.g. superparamagnetic particles) in the neighborhood of the sensor, cause a rotation of the free magnetic layer's magnetic orientation, which in turn, increases or decreases the resistance of the GMR structure. Low resistance generally occurs when the sensor and pinned layers are magnetically oriented in a same direction. Higher resistance occurs when the magnetic orientations of the sensor and pinned layers are opposite to each other.

TMR can be observed in systems made of two ferromagnetic electrode layers separated by an isolating (tunnel) barrier. This barrier must be very thin, i.e. must be in the order of 1 nm, for the electrons to be able to tunnel through this barrier. This is a quantum-mechanical transport process. The magnetic alignment of one layer can be changed without affecting the other by making use of an exchange bias layer. Changes in the magnetic field, which according to embodiments of the present invention originate from changes in the magnetization of magnetic material such as, for example, superparamagnetic nanoparticles, cause a rotation of the magnetic orientation of one of the ferromagnetic electrode layers, which in turn, increases or decreases resistance of the TMR structure.

The AMR of ferromagnetic materials is the dependence of the resistance on the angle the current makes with the magnetization direction. This phenomenon is due to an asymmetry in the electron scattering cross section of ferromagnet materials.

The present invention will be described by means of GMR elements, but it has to be understood that this is not limiting the invention in any way and that, instead of these GMR elements, any other means which have a property or parameter which depends on the magnetic field such as the above described TMR or AMR elements can also be applied.

FIG. 3 illustrates a cross-section of a magnetoresistive sensor 20 according to an embodiment of the present invention. The magnetoresistive sensor 20 comprises a magnetoresistive element 21, in the example given a GMR element, and a magnetic field generator, in the example given comprising two electrical conductors 22.

Due to asymmetric current distribution in the magnetoresistive sensor 20 which, according to the present example, comprises a GMR element 21 comprising a GMR stack, the sense current Iₛₑₙₛₑ will introduce an in-plane magnetic field component Hᵢₙₜ, indicated by arrow 23 in FIG. 3:

Hᵢₙₜ=α·Iₛₑₙₛₑ (2)

wherein α is a constant value and Iₛₑₙₛₑ is the sense current which is sent through the magnetoresistive element 21, in the example given the GMR element. The in-plane magnetic field component 23 will also be sensed by the magnetoresistive element 21, in the example given the GMR element. The effect of the in-plane magnetic field component Hᵢₙₜ can be interpreted as internal magnetic crosstalk.

FIG. 4 shows a cross-section of a GMR element 21 comprising a GMR stack 24 in which the sense current Iₛₑₙₛₑ through the GMR stack 24 is schematically indicated. The GMR stack 24 comprises a non-magnetic layer 25, a free or sensitive magnetic layer 26 and a pinned layer 27. The current distribution in the GMR stack 24 is centered in the non-magnetic layer 25 between the free or sensitive layer 26 and the pinned layer 27. Moving the center of gravity of the sense current Iₛₑₙₛₑ to an optimal position just below the free or sensitive layer 26 results in more magnetic field strength being induced by the sense current Iₛₑₙₛₑ in the free or sensitive layer 26, which increases the control range and the gain of the stabilizing circuitry. This can be achieved by optimizing the resistance balance in the stack, e.g. by adding a low-ohmic layer to the stack or by changing the thickness of the different layers in the GMR stack 24. For example, the resistance balance can be changed by changing the thickness of the free magnetic layer, e.g. the NiFe layer and/or the thickness of the pinned magnetic layer, e.g. the CoFe layer. The above-defined parameters α and s_{GMR} both are a function of the current distribution in the GMR stack 24.

The in-plane magnetic field component generated by the sense current Iₛₑₙₛₑ in the magnetoresistive element 21 itself is indicated by arrow 23 in FIG. 3, as described above. Because of this in-plane magnetic field component 23 generated by the sense current Iₛₑₙₛₑ in the magnetoresistive element 21, e.g. GMR element, itself, the resulting sense signal, and thus any signal derived from this sense signal, e.g. an electrical output signal derived from the sense signal, does not lead to a reliable measurement value with respect to, for example, target molecules to be detected, because the sensed signal does not solely originate from the external magnetic field, e.g. magnetic field generated by magnetizable objects attached to target molecules. As a cause of, for example, an unstable current source, this in-plane magnetic field component 23 may furthermore change over time and lead to an unstable electrical output signal.

FIG. 5 shows part of a magnetic sensor 20 in which, besides the external magnetic field Hₑₓₜ, e.g. originating from magnetizable objects, e.g. magnetic nanoparticles, also the internal magnetic field Hᵢₙₜ generated by the sense current Iₛₑₙₛₑ in the magnetoresistive element 21, e.g. GMR element, itself is indicated. A current source 28 supplies a sense current Iₛₑₙₛₑ=I₂ sin(ω₂t) to the magnetoresistive element 21, e.g. GMR element. The sense current Iₛₑₙₛₑ causes a sense signal U_{GMR} across the magnetoresistive element 21, e.g. GMR element. The sense signal U_{GMR} may then be amplified by an amplifier 29 which delivers the signal U_{AMP}. As described above, the sense current Iₛₑₙₛₑ generates an in-plane magnetic field component 23 (see eq. (2)) in the sensitive layer 26 of the GMR element 21. The effect of the in-plane magnetic field component Hᵢₙₜ can be interpreted as internal magnetic crosstalk and will give rise to a voltage component:

eᵢₙₜ=s_{GMR}·α·Iₛₑₙₛₑ² (3)

in the signal U_{GMR}. As a result, the sense signal U_{GMR} comprises a DC component, which, according to the present invention, will be used to obtain an electrical output signal U₀ with stabilized amplitude. This is illustrated as follows. The total in-plane magnetization Hₓ in the sensitive layer 26 of the GMR element 21 equals:

Hₓ=Hₑₓₜ+α·Iₛₑₙₛₑ (4)

The sense signal U_{GMR} can be expressed by:

U_{GMR}=Iₛₑₙₛₑ(R_{GMR}+s_{GMR}·(Hₑₓₜ+α·Iₛₑₙₛₑ))=Iₛₑₙₛₑ(R_{GMR}+s_{GMR}·Hₑₓₜ)+Iₛₑₙₛₑ²·s_{GMR}·α (5)

By substituting Iₛₑₙₛₑ=I₂ sin ω₂t, the sense signal U_{GMR} can be written as:

U_{GMR}=I₂ sin ω₂t·(R_{GMR}+s_{GMR}·Hₑₓₜ)+I₂² sin ω₂t·s_{GMR}·α (6)

Assume the magnetic field from the beads Hₑₓₜ=H₁ sin ω₁t, then after some calculation the following is obtained:

$${U}_{GMR} = \frac{1}{2} {I}_{2}^{2} \cdot {s}_{GMR} \cdot α - \frac{1}{2} {I}_{2}^{2} \cdot {s}_{GMR} \cdot α \cdot cos 2 {ω}_{2} t + \frac{1}{2} {I}_{2} \cdot {s}_{GMR} \cdot {H}_{1} [ cos ( {ω}_{1} - {ω}_{2} ) t - cos ( {ω}_{1} + {ω}_{2} ) t ] \qquad ( 7 )$$

The first term in eq. (7) is a DC component and will also be referred to as gain indicator G. The DC component or gain indicator G equals:

$$G = \frac{1}{2} {I}_{2}^{2} \cdot {s}_{GMR} \cdot α \qquad ( 8 )$$

This DC component or gain indicator G will, according to the present invention, be used for stabilizing the amplitude of the electrical output signal.

Therefore, according to the present invention, the electronic read out means of the magnetoresistive sensor 20 comprises stabilizing circuitry for stabilizing the amplitude of the electrical output signal, thereby leading to a reliable measurement value, which does not suffer from variations in the sensitivity s_{GMR} of the magnetoresistive element (21) or variations in I₂ or amplitude of the sense current Iₛₑₙₛₑ or in other words fluctuations of the current source 28.

Hereinafter the invention will be described by means of different embodiments.

A magnetoresistive sensor 20 according to a first embodiment of the present invention is schematically illustrated in FIG. 6. The magnetoresistive sensor 20 may comprise a magnetic field generator (not shown in the figure) which may be a magnetic field generator external or internal to a substrate in which the sensor 20 is provided, to provide an external magnetic field Hₑₓₜ. An example of a magnetic field generator internal to the substrate in which the sensor 20 is provided may, for example, comprise two current conductors 22 as illustrated in FIG. 3. The magnetoresistive sensor 20 may furthermore comprise at least one magnetoresistive element 21, a current source 28 for flowing a sense current Iₛₑₙₛₑ through the at least one magnetoresistive element 21 thereby generating a sense signal U_{GMR}, and electronic means 30 for generating an electrical output signal U₀ derived from the sense signal U_{GMR}, the electronic means 30 at least comprising stabilizing circuitry 30a for stabilizing the amplitude of the electrical output signal U₀ and thus for obtaining an electrical output signal U₀ with stabilised amplitude. With stabilised amplitude is meant that the electrical output signal U₀ is not sensitive to or does not depend on the sensitivity s_{GMR} of the magnetoresistive sensor element 21 and is not sensitive to or does not depend on variations in I₂, i.e. to variations of the amplitude of the sense current Iₛₑₙₛₑ delivered by current source 28.

The stabilizing circuitry 30a comprises means for determining a DC component in the sense signal U_{GMR} and means for stabilizing the amplitude of the electrical output signal U₀ and thus serves to obtain an electrical output signal U₀ with stabilised amplitude, by using the DC component.

According to the present embodiment, the stabilizing circuitry 30a may comprise a low-pass filter 31, preferably a DC or 0 Hz filter, for extracting the DC component, also called gain indicator G, from the sense signal U_{GMR}:

$$G = \frac{1}{2} {I}_{2}^{2} \cdot {s}_{GMR} \cdot α \qquad ( 9 )$$

The low-pass filter 31 may be a low-order filter, preferably a 1^{st} to 3^{rd} order filter. The stabilizing circuitry 30a may furthermore comprise a normalizer 32 having a signal input coupled to the output of amplifier 29 for receiving the signal U_{AMP}, which is the amplified sense signal U_{GMR}, and having a signal output coupled to an input of a multiplier 33 for delivering the signal Uₙₒᵣₘ. The gain indicator G is coupled in a feed forward loop to the normalizer 32. In the normalizer 32, the signal U_{AMP} is controlled according to:

$${U}_{norm} = \frac{{U}_{AMP}}{\sqrt{G}} \qquad ( 10 )$$

In a practical implementation gainₘₐₓ, as indicated in FIG. 6, limits the maximal gain of the normalizer 32 according to:

$${U}_{norm} = \frac{{U}_{AMP}}{\sqrt{G + {gain}_{max}}} \qquad ( 11 )$$

in order to avoid excessive noise amplification when G=0. The operation of the normalizer 32 is well-known by persons skilled in the art and will therefore not be described.

The signal Uₙₒᵣₘ is a signal of which the amplitude is stabilized by using the DC component or gain indicator G. The thus stabilized signal Uₙₒᵣₘ may then be synchronously demodulated by the multiplier 33 which multiplies the signal Uₙₒᵣₘ with either cos (ω₁−ω₂)t or cos (ω₁+ω₂)t , or with a combination of these signals. The resulting signal UMP at the output of the amplifier 33 may then be filtered by low-pass filter 34 which delivers the electrical output signal U₀ which is a measure related to the external magnetic field, e.g. a measure for the concentration of magnetizable objects, e.g. magnetic nanoparticles, present at the magnetoresistive sensor 20 and thus, in this case, is a measure for the concentration of target molecules, e.g. biological molecules, which were to be determined. The electrical output signal U₀ does not suffer from variations in sensitivity s_{GMR} and from variations in the amplitude of the sense current Iₛₑₙₛₑ (I₂).

In a second embodiment according to the present invention, which is illustrated in FIG. 7, the stabilizing circuitry 30a may comprise a subtractor 35 in which a predetermined value sp_{AGC} is subtracted from the amplified sense signal U_{AMP}. The predetermined value sp_{AGC} is the desired G-value or set point. The control loop adjusts the sense current amplitude to reach that value. The value for sp_{AGC} may be any value between a minimum value determined by the required signal-to-noise ratio, and a maximum value determined by the allowed power dissipation in the sensor element 21.

The resulting signal is an error signal Uₑᵣᵣ and is delivered to an integrating loop filter 36. The predetermined value sp_{AGC} determines the operating point of the negative feedback loop formed by the amplifier 29, the subtractor 35, the integrating loop filter 36, the current source 28 and the magnetoresistive element 21, e.g. GMR element. The output signal of the integrating loop filter 36, may then be used to adapt the amplitude of the sense current Iₛₑₙₛₑ delivered by the current source 28. Therefore, if the gain of the feedback loop is sufficiently high, the error signal Uₑᵣᵣ at the output of the subtractor 35 or at the input of the integrating loop filter 36 will be controlled to approximately zero. Therefore, the effective sensitivity of the magnetoresistive sensor 20 will be equal to the predetermined value and is thus stabilized. The thus stabilized signal U_{AMP} may then be synchronously demodulated by multiplier 33 which multiplies this signal with either cos(ω₁−ω₂)t or cos(ω₁+ω₂)t or with a combination of these signals. The resulting signal UMP at the output of the multiplier 33 may then be filtered by low-pass filter 34 and delivers the electrical output signal U₀ which is related to the external magnetic field, e.g. which is a measure for the concentration of magnetizable objects, e.g. magnetic nanoparticles, present at the surface of the magnetoresistive sensor 20 and attached to target molecules, and thus is a measure for the concentration of target molecules, e.g. biological molecules, which were to be determined. The electrical output signal U₀ does not suffer variations in the sensitivity s_{GMR} of the magnetoresistive element 21 or variations in I₂ or amplitude of the sense current Iₛₑₙₛₑ or in other words fluctuations of the current source 28.

Another embodiment according to the present invention is illustrated in FIG. 8. In this embodiment the stabilizing circuitry 30a may, similar to the embodiment described in FIG. 7, comprise a subtractor 35 and an integrating loop filter 36. In the subtractor 35 a predetermined value sp_{AGC} is subtracted from the signal U_{AMP}. The predetermined value sp_{AGC} is the desired G-value or set point. The control loop adjusts the sense current amplitude to reach that value. The value for sp_{AGC} may be between a minimum value determined by the required signal-to-noise ratio, and a maximum value determined by the allowed power dissipation in the sensor.

The resulting signal is an error signal Uₑᵣᵣ and is delivered to the integrating loop filter 36.

According to this embodiment, the stabilizing circuitry 30a may furthermore comprise a second multiplier 37 with a first input coupled to the output of the amplifier 29. According to the present embodiment, the output of the integrating loop filter 36 is not coupled to the current source 28, as was the case in the embodiment described above and illustrated in FIG. 7, but to a second input of the multiplier 37. Thus the amplified sense signal U_{AMP} is multiplied with the gain indicator G. The multiplier 37 is used to influence the amplitude of the signal U_{AMP} under the control of the output of the integrated loop filter 36.

It has to be noted, that although there is a large resemblance between the implementation of the magnetoresistive sensor 20 in FIG. 7 and FIG. 8, the principle of operation of these two circuits is different. The principle of operation of the circuit illustrated in FIG. 8 is similar to the principle of operation of the circuit illustrated in FIG. 6. In FIGS. 6 and 8 the amplitude of the electrical output signal U₀ is controlled purely electronically, whereas in FIG. 7 the magnetoresistive element 21 is used as ‘gain multiplier’.

Basically, according to the present embodiment, the negative feedback loop formed by the second multiplier 37, the subtractor 35 and the integrating loop filter 36 performs a similar function as the feed forward loop formed by the low-order low-pass filter 31 and the normalizer 32 in FIG. 6, i.e. the amplitude of the amplified sense signal is stabilised by direct combination thereof with the gain indicator G. This is different from the principle of operation of the embodiment illustrated in FIG. 7, where the amplitude of the amplified sense signal is stabilised by changing the sense current Iₛₑₙₛₑ by means of the gain indicator G.

It is furthermore to be noted that, with respect to the implementation of the magnetoresistive sensor 20 according to FIG. 7, the implementation according to FIG. 8 will suffer less from possible complication for the design with respect to, for example, stability, because the feedback loop contains less elements in the loop as, contrary to the implementation according to FIG. 7, the controllable current source 28 and the GMR element 21 are not present in the feedback loop.

By interpreting the DC component in the sense signal U_{GMR} as a gain indicator rather than using the 2^{nd} (or higher) harmonic in the sense signal as in prior art solutions, the drawbacks which appear in the magnetoresistive sensors according to those prior art solutions can be limited or even omitted.

A further advantage of the magnetoresistive sensor 20 according to the present invention is that it furthermore suppresses variations in the sense current Iₛₑₙₛₑ so that a controllable high ohmic voltage source may be used instead of a real current source for delivering the sense current Iₛₑₙₛₑ. This eases the implementation of a low-noise sense current generator 28. A low-noise voltage source is easier to realize by, for example, filtering the output in the frequency domain.

The in-plane magnetic field component Hᵢₙₜ generated by the sense current Iₛₑₙₛₑ in the magnetoresistive element 21, in the example given the GMR element, itself, is concentrated in the magnetoresistive element 21, e.g. GMR element, so that there is a neglectable interaction between the magnetisable objects, e.g. magnetic nanoparticles, at the surface of the magnetoresistive sensor 20 and the sense current Iₛₑₙₛₑ applied to the magnetoresistive element 21, e.g. GMR element. Therefore, according to the present invention, in embodiments where the external magnetic field is measured through interaction with magnetisable objects, also called magnetic beads, correction for this in-plane magnetic field component generated by the magnetoresistive element 21, e.g. GMR element, itself can be applied simultaneously with the actual magnetic bead measurement.

It has to be noted that the harmonic distortion components due to the non-linear magnetoresistive, e.g. GMR, characteristic are neglectable because of the small AC amplitude of the magnetic field induced by the sense current Iₛₑₙₛₑ. This is because, for the applied magnetic field amplitudes, the R(H) characteristic (see FIG. 2) can be assumed linear.

In another aspect, the present invention also provides a biochip comprising at least one magnetoresistive sensor 20 according to embodiments of the present invention. FIG. 9 illustrates a biochip 40 according to an embodiment of the present invention. The biochip 40 may comprise at least one magnetoresistive sensor 20 according to embodiments of the present invention integrated in a substrate 41. The term “substrate” may include any underlying material or materials that may be used, or upon which a device, a circuit or an epitaxial layer may be formed. The term “substrate” may include a semiconductor substrate such as e.g. a doped silicon, a gallium arsenide (GaAs), a gallium arsenide phosphide (GaAsP), an indium phosphide (InP), a germanium (Ge), or a silicon germanium (SiGe) substrate. The “substrate” may include, for example, an insulating layer such as a SiO₂ or an Si₃N₄ layer in addition to a semiconductor substrate portion. Thus the term “substrate” also includes glass, plastic, ceramic, silicon-on-glass, silicon-on-sapphire substrates. The term “substrate” is thus used to define generally the elements for layers that underlie a layer or portions of interest. Also the “substrate” may be any other base on which a layer is formed, for example a glass or metal layer.

According to embodiments of the invention a single magnetoresistive sensor 20 or a multiple of magnetoresistive sensors 20 may be integrated on the same substrate 41 to form the biochip 40.

The magnetic field generator 22 of the magnetoresistive sensors 20 may be magnetic field generators external to the substrate 41, or, as in the present example illustrated in FIG. 9, may also be integrated in the substrate 41. According to the present example, the magnetic field generator 22 may comprise a first and a second electrical conductor, e.g. implemented by a first and second current conducting wire 22a and 22b. Also other means instead of current conducting wires 22a, 22b may be applied to generate the external magnetic field. Furthermore, the magnetic field generator 22 may also comprise another number of electrical conductors. According to other embodiments, the magnetic field generator 22 may also be located outside the substrate 41.

In each magnetoresistive sensor 20 at least one magnetoresistive element 21, for example a GMR element, may be integrated in the substrate 41 to read out the information gathered by the biochip 40, thus for example to read out the presence or absence of target particles 43 via magnetizable objects 45, e.g. magnetic nanoparticles, attached to the target particles 43, thereby determining or estimating an areal density of the target particles 43. The magnetizable objects 45, e.g. magnetic particles, are preferably implemented by so called superparamagnetic beads. Binding sites 42 which are able to selectively bind a target molecule 43 are attached on a probe element 44. The probe element 44 is attached on top of the substrate 41.

The functioning of the biochip 40, and thus also of the magnetoresistive sensor 20, will be explained hereinafter. Each probe element 44 may be provided with binding sites 42 of a certain type, for binding pre-determined target molecules 43. A target sample, comprising target molecules 43 to be detected, may be presented to or passed over the probe elements 44 of the biochip 40, and if the binding sites 42 and the target molecules 43 match, they bind to each other. The superparamagnetic beads 45, or more generally the magnetizable objects, may be directly or indirectly coupled to the target molecules 43. The magnetizable objects, e.g. superparamagnetic beads 45, allow to read out the information gathered by the biochip 40.

In the embodiment illustrated in FIG. 9, the external magnetic field magnetizes the magnetizable objects, e.g. the superparamagnetic beads 45, which as a response generate a magnetic field which can be detected by the magnetoresistive element 21, e.g. GMR element. Although not necessary, the magnetoresistive element 21, e.g. GMR element, should preferably be positioned in such a way that the parts of the response magnetic field generated by the magnetizable objects 45 which pass through the magnetoresistive element 21, e.g. GMR element, lie in the sensitive direction of the magnetoresistive element 21, e.g. GMR element.

According to embodiments of the present invention, the biochip 40 may comprise an array of magnetoresistive sensors 20 in which one magnetoresistive sensor 20 acts as a reference sensor and in which the amplitude of the electrical output signal U₀ of the other magnetoresistive sensors 20 is stabilized with the help of information derived from the reference sensor. According to these embodiments, it is assumed that the gain variations are the same for each magnetoresistive sensor 20 in the array. This is a good assumption since the sensors 20 are located close to each other on a same biochip 40.

The magnetoresistive sensor 20, biochip 40 and the method according to the present invention may be used in molecular diagnostics, biological sample analysis or chemical sample analysis.

It is to be understood that although preferred embodiments, specific constructions and configurations, as well as materials, have been discussed herein for devices according to the present invention, various changes or modifications in form and detail may be made without departing from the scope and spirit of this invention.

1. A magnetoresistive sensor (20) comprising:
a magnetic field generator (22) for generating a magnetic field,
at least one magnetoresistive element (21) for sensing the magnetic field,
a current source (28) for flowing a sense current (Iₛₑₙₛₑ) through the at least one magnetoresistive element (21) thus generating a sense signal (U_{GMR}) which depends on the sensed magnetic field, and
electronic means (30) for generating an electrical output signal (U₀) having an amplitude and being derived from the sense signal (U_{GMR}), the electronic means (30) comprising stabilizing circuitry (30a),
wherein the stabilizing circuitry (30a) comprises means for determining a DC component (G) in the sense signal (U_{GMR}) and means for stabilizing the amplitude of the electrical output signal (U₀) in response to said DC component (G).

2. A magnetoresistive sensor (20) according to claim 1, wherein the means for determining the DC component (G) comprises a low-pass filter (31).

3. A magnetoresistive sensor (20) according to claim 2, wherein the low-pass filter is a low-order low-pass filter (31).

4. A magnetoresistive sensor (20) according to claim 2, wherein the means for stabilizing the amplitude of the electronic output signal (U₀) comprises a normalizer (32) controlled by the magnitude of the DC component in the sense signal (U_{GMR}).

5. A magnetoresistive sensor (20) according to claim 1, wherein the stabilising circuitry (30a) comprises a feedforward loop.

6. A magnetoresistive sensor (20) according to claim 1, wherein the stabilising circuitry (30a) comprises a feedback loop.

7. A magnetoresistive sensor (20) according to claim 6, wherein the feedback loop comprises a subtractor (35) and an integrating loop filter (36).

8. A magnetoresistive sensor (20) according to claim 6, wherein the feedback loop furthermore comprises a multiplier (37).

9. A magnetoresistive sensor (20) according to claim 1, wherein the electrical means (30) furthermore comprises an amplifier (29) for amplifying the sense signal (U_{GMR}).

10. A magnetoresistive sensor (20) according to claim 1, wherein the magnetoresistive element (21) is a GMR, a TMR or an AMR element.

11. A magnetoresistive sensor (20) according to claim 1, wherein the magnetic field generator (22) comprises at least one electrical conductor.

12. A magnetoresistive sensor (20) according to claim 11, wherein the at least one electrical conductor is formed by at least one conducting wire (22a, 22b).

13. A magnetoresistive sensor (20) according to claim 1, wherein
the magnetic field generator (22) is adapted for magnetizing a magnetizable object, and
the at least one magnetoresistive element (21) is adapted for sensing a magnetic field generated by the magnetizable object when magnetized.

14. A biochip (40) comprising at least one magnetoresistive sensor (20) according to claim 13.

15. A biochip (40) according to claim 14, comprising a plurality of magnetoresistive sensors (20), wherein at least one magnetoresistive sensor (20) is used as reference sensor and wherein stabilization of the amplitude of the electrical output signal (U₀) of the magnetoresistive sensors (20) is performed by using information derived from the at least one reference sensor.

16. Use of the magnetoresistive sensor (20) according to claim 13 in molecular diagnostics, biological sample analysis or chemical sample analysis.

17. Use of the biochip (40) according to claim 14 in molecular diagnostics, biological sample analysis or chemical sample analysis.

18. Use of the biochip (40) according to claim 15 in molecular diagnostics, biological sample analysis or chemical sample analysis.

19. A method for stabilizing the amplitude of an electrical output signal (U₀) of a magnetoresistive sensor (20), the method comprising:
generating a magnetic field,
generating a sense signal (U_{GMR}) indicative for the magnetic field induced by a sense current (Iₛₑₙₛₑ) in a magnetoresistive element (21), and
generating an electrical output signal (U₀) derived from said sense signal (U_{GMR}),
wherein the method furthermore comprises:
determining a DC component (G) from said sense signal (U_{GMR}), and
stabilizing the amplitude of the electrical output signal (U₀) indicative for the magnetic field in response to said determined DC component (G).

20. A method according to claim 19, wherein determining a DC component (G) is performed by extracting said DC component (G) from the sense signal (U_{GMR}) by low-pass filtering.

21. A method according to claim 20, wherein stabilizing the amplitude of the electrical output signal (U₀) is performed by a normalizer (32).

22. A method according to claim 19, wherein
generating a magnetic field comprises generating a magnetic field for magnetizing a magnetizable object, and wherein
sensing the magnetic field comprises sensing the magnetic field generated by said magnetizable object when magnetized.

23. Use of the method according to claim 22 in molecular diagnostics, biological sample analysis or chemical sample analysis.
